(19) United States
(12) Patent Application Publication
(10) Pub. No.: US 2004/0021933 A1
(43) Pub. Date: Feb. 5, 2004

(54) Lens and microscope

(76) Inventor: Bernd Ozygus, Berlin (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/343,599

(22) PCT Filed: Jul. 31, 2001
(86) PCT No.: PCT/EP01/08838

(30) Foreign Application Priority Data
Aug. 4, 2000 (DE) 100 39 338.1

(51) Int. Cl. G02B 1/00

(52) U.S. Cl. 359/350

(57) ABSTRACT

The invention relates to a lens (4, 13) and a laser processing device comprising a microscope (15) having a lens, and a laser (5) which emits a laser beam (8, 11) for processing a workpiece (9). The lens (4, 13) has an outer optic (12) comprising a central opening in which an inner optic (10) is arranged.

The present invention relates to a lens.

Moreover, the present invention relates to a laser processing system including a microscope having a lens, and a laser which emits a laser beam for machining a workpiece.

Micromachining with solid-state laser systems is an already well-introduced technology which is finding wider and wider applications because of its physical advantages. Here, the field of application ranges from varied forms of machining in the metal field (welding, drilling, cutting, marking) to medicine and biology Many special processing tasks can only be accomplished with lasers. Besides the small spot diameter of the laser beam on the workpiece or the sample, good visual control of the process is important for the processing result. A way to achieve this is to use a stereomicroscope in which the laser is coupled into the optical path of the stereomicroscope. In the designs currently in use, the laser beam is coupled into the beam path of the microscope via a fixed dichroic mirror which is simultaneously used by the monitoring beam path and the laser beam path. Focusing of the laser and monitoring are carried out via the same lens. In order to achieve a smaller spot diameter of the laser beam on the workpiece or the sample, the laser beam is widened in a suitable manner using a telescope. The monitoring of the processing operation is done via a magnification changer or a zoom optical system using the microscope eyepieces or a CCD camera.

For many special materials, laser processing is only possible with ultraviolet radiation. The higher energy of the laser photons allows direct breaking of molecular bonds and eliminates the need for interaction by thermal processes. The zone of thermal influence becomes smaller, thus reducing the processing spot of the laser. Moreover, due to the smaller wavelength, markedly smaller focus diameters of the laser beam are possible. However, a problem in using ultraviolet radiation is the small number of usable optical materials. The usual glass types are no longer sufficiently transparent for wavelengths below 400 nm. Here, frequently optics made of quartz glass are used. In order to use ultraviolet radiation in a stereomicroscope of the design known heretofore, the lens would have to be sufficiently transparent for the laser wavelength and, at the same time, have excellent imaging properties for the visible spectral range. Lenses of this type are extremely complex and expensive.

Therefore, the object of the present invention is to specify a lens which can be simultaneously used for processing a workpiece, especially using UV lasers, and for workpiece monitoring in an inexpensive and flexible manner.

The above object is achieved by a lens which features an outer optic having a central opening in which is positioned an inner optic.

A further object of the present invention is to specify a laser processing system which allows processing of a workpiece, especially using UV lasers, and workpiece monitoring in an inexpensive, flexible and precise manner.

The above object is achieved by a laser processing system which has the feature that the lens has an outer optic having a central opening in which is positioned an inner optic.

The present invention has the advantage that workpiece monitoring and workpiece processing, especially using ultraviolet radiation, are possible in a structurally simple and inexpensive manner. Moreover, already developed lenses that are designed only for workpiece monitoring can be easily retrofitted to allow simultaneous use of an ultraviolet processing laser.

In a preferred embodiment, the UV optic for the laser beam is located in the previously removed central region of the monitoring optic. Here, one takes advantage of the fact that the monitoring beam path and the laser beam path are spatially separated within the lens. In this manner, it is possible to separately optimize the outer optic for monitoring and the inner optic for the processing. Preferably, the outer optic is optimized for visible light. The inner optic has a different, preferably smaller focal length than the outer optic. In this manner, small focus diameters are achieved for the processing laser beam.

A laser processing system including a stereomicroscope is especially advantageous. The central region of the lens, which is not designed for service in a laser processing system, is bored out, forming an outer optic. An inner optic, which is a UV optic, is inserted into resulting the opening. The laser beam defines a laser beam path in which the inner optic is positioned. The monitoring light originating from the workpiece defines a monitoring beam path in which the outer optic is positioned.

In a preferred embodiment, at least parts of the outer optic are also positioned in the laser beam path, or parts of the inner optic are also positioned in the monitoring beam path.

The subject matter of the invention is schematically represented in the drawing and is described below with reference to the Figures, in which equally acting elements are denoted by the same reference numerals. In this context,

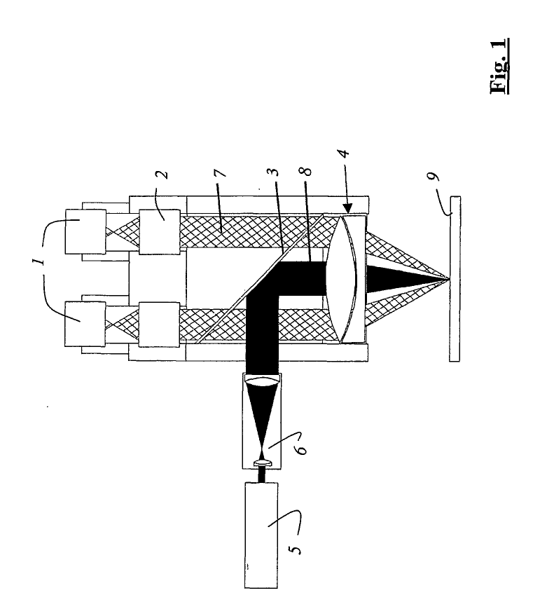

FIG. 1 shows a laser processing system according to the prior art; and

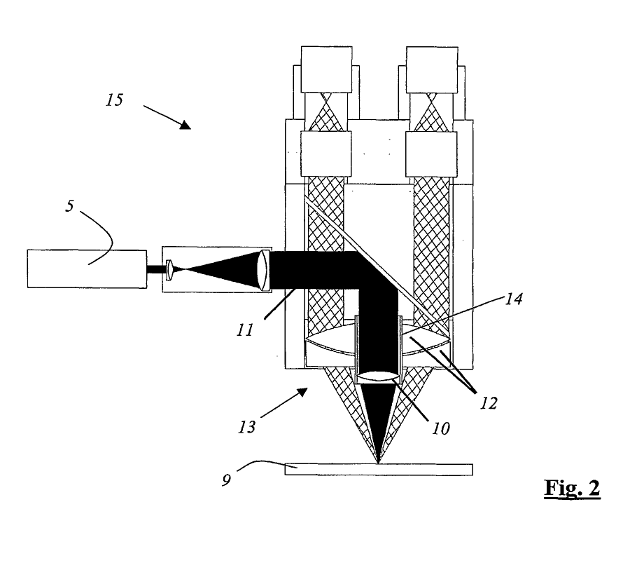

FIG. 2 shows a laser processing system according to the present invention.

FIG. 1 depicts an optical device according to the prior art. The laser beam is coupled into the optical path of the microscope via a fixed dichroic mirror 3 which is simultaneously used by monitoring beam 7 and laser beam 8. The focusing of laser 5 and monitoring are carried out via the same lens 4. In order to achieve a smaller spot diameter of laser beam 8 on workpiece 9 or the sample, the laser beam is widened in a suitable manner using a telescope 6. The monitoring of the processing operation is done using a magnification changer or a zoom optical system 2 using the microscope eyepieces 1 or a CCD camera.

FIG. 2 shows a laser processing system including a microscope 15 which is designed as a stereomicroscope. Lens 13 has an inner optic 10 and an outer optic 12. Inner optic 10 is held in a mount 14 and designed as a UV optic. The inner optic is located in the previously-removed central region of outer optic 12, which constitutes the monitoring optic in this embodiment. Laser beam 11, which is emitted by laser 5, is focused by inner optic 10. Here, one takes advantage of the fact that the monitoring beam path and the laser beam path are spatially separated within the lens. In this manner, it is possible to separately optimize the outer optic for monitoring and the inner optic for the processing. The use of a lens according to the present invention in the laser processing system shown also has the advantage that smaller focal lengths can be used for the laser beam path, whereby smaller focus diameters are possible.

The present invention has been explained with reference to a specific embodiment. However, it is obvious that changes and modifications can be made without thereby exceeding the scope of the following claims.

List of Reference Numerals

| | |
|---|---|
| 1 | microscope eyepieces |
| 2 | zoom optical system |
| 3 | dichroic mirror |
| 4 | lens |
| 5 | laser |
| 6 | telescope |
| 7 | monitoring beams |
| 8 | laser beam |
| 9 | workpiece |
| 10 | inner optic |
| 11 | laser beam |
| 12 | outer optic |
| 13 | lens |
| 14 | mount |
| 15 | microscope |

What is claimed is:

1. A lens (4, 13),
wherein the lens (4, 13) features an outer optic (12) having a central opening in which is positioned an inner optic (10).

2. The lens (4, 13) as recited in claim 1,
wherein the inner optic (10) is a UV optic.

3. The lens (4, 13) as recited in claim 1,
wherein the outer optic (12) is optimized for visible light.

4. The lens (4, 13) as recited in claim 1,
wherein the lens (4, 13) is insertable into a microscope (15).

5. The lens (4, 13) as recited in claim 1,
wherein the inner optic (10) has a different focal length than the outer optic (12).

6. A laser processing system comprising a microscope (15) having a lens (4, 13), and a laser (5) which emits a laser beam (8, 11) for machining a workpiece (9),
wherein the lens (4, 13) features an outer optic (12) having a central opening in which is positioned an inner optic (10).

7. The laser processing system as recited in claim 6,
wherein the microscope (15) is a stereomicroscope.

8. The laser processing system as recited in claim 6,
wherein the inner optic (10) is a UV optic.

9. The laser processing system as recited in claim 6,
wherein the outer optic (12) is optimized for visible light.

10. The laser processing system as recited in claim 6,
wherein the inner optic (10) has a different focal length than the outer optic (12).

11. The laser processing system as recited in claim 6,
wherein the laser beam (8, 11) defines a laser beam path in which the inner optic (10) is positioned.

12. The laser processing system as recited in claim 6,
wherein monitoring light originating from the workpiece defines a monitoring beam path in which the outer optic (12) is positioned.

13. The laser processing system as recited in claim 11,
wherein at least parts of the outer optic (12) are positioned in the laser beam path.

14. The laser processing system as recited in claim 12,
wherein at least parts of the inner optic (10) are positioned in the monitoring beam path.

21. (new) The lens as recited in claim 15 wherein the inner optic is disposed outside a plane of the outer optic.

22. (new) A laser processing system comprising:
a laser configured to emit a laser beam for machining a workpiece; and
a microscope including a lens, the lens including an outer optic defining a central opening and an inner optic disposed in the central opening.

23. (new) The laser processing system as recited in claim 22 wherein the microscope includes a stereomicroscope.

24. (new) The laser processing system as recited in claim 22 wherein the inner optic includes a UV optic.

25. (new) The laser processing system as recited in claim 22 wherein the outer optic is optimized for visible light.

26. (new) The laser processing system as recited in claim 22 wherein the inner optic has a different focal length than the outer optic.

27. (new) The laser processing system as recited in claim 22 wherein the laser beam defines a laser beam path, the inner optic being disposed in the laser beam path.

28. (new) The laser processing system as recited in claim 27 wherein at least a part of the outer optic is disposed in the laser beam path.

29. (new) The laser processing system as recited in claim 22 wherein the outer optic is disposed in a monitoring beam path of monitoring light originating from the workpiece.
